(19) United States
(12) Patent Application Publication
(10) Pub. No.: US 2025/0299215 A1
(43) Pub. Date: Sep. 25, 2025

(54) CLUSTERING USERS ACCORDING TO CAUSAL RELATIONSHIPS AMONG USER DATA

(71) Applicant: ADOBE INC., SAN JOSE, CA (US)

(72) Inventors: Vibhor Porwal, Bidhuna (IN); Harshita Chopra, Delhi (IN); Atanu R. Sinha, Bangalore (IN); Sharda Kriti Modanwal, Varanasi (IN); Chetan Reddy Narayanaswamy, Bengaluru (IN); Zainul Niaz, Lucknow (IN)

(21) Appl. No.: 18/609,625

(22) Filed: Mar. 19, 2024

(51) Int. Cl. G06Q 30/0204; G06Q 30/0251

(52) U.S. Cl. CPC G06Q 30/0204; G06Q 30/0253

(57) ABSTRACT

Methods, non-transitory computer readable media, apparatuses, and systems for data processing include obtaining, by a machine learning model, a user cluster and interaction data for users in the user cluster, where the interaction data relates to interactions between the users and a digital platform. Some embodiments further include generating, by the machine learning model, a directed graph based on the user cluster and the interaction data, where the directed graph represents causal relationships among the interactions. Some embodiments further include updating, by the machine learning model, the user cluster based on the directed graph. Some embodiments further include providing, by a content component, customized content to a user via the digital platform based on the updated user cluster.

### BACKGROUND

The following relates generally to data processing, and more specifically to clustering users according to causal relationships among user data. User clustering refers to grouping users according to some pattern in data corresponding to the users. Identifying clusters of users is important in a communications context, because the underlaying user data that informs the clustering allows cluster-targeted content to be provided to a user included in a cluster according to a predicted effect that the content will have on the user.

Some conventional data processing systems cluster a set of users according to similarities in observed user data, using homogenous clustering criteria for each of the clusters. However, homogenous user clustering ignores causal effects among user data corresponding to sub-groups of the set of users, leading to a relatively inaccurate identification of key performance indicators for the user clusters. There is therefore a need in the art for user clustering systems and methods that identify user clusters with an increased accuracy.

### SUMMARY

Embodiments of the present disclosure provide a machine learning model for obtaining a user cluster of users of a digital platform, generating a directed graph representing causal relations among interactions between the users and the digital platform based on the user cluster, and updating the user cluster based on the directed graph. In some cases, by updating the user cluster based on the directed graph representing the causal relations among interactions between the users and the digital platform, the machine learning model recognizes heterogeneity among causal relations of sub-groups of users, where the sub-groups are not defined (e.g., a priori or exogenously) by a similarity in interactions, but are characterized by the causal relations among the interactions.

Accordingly, in some cases, a data processing system including the machine learning model provides customized content to a user included in the user cluster based on the updated user cluster. By providing the customized content based on the user cluster, the data processing system provides the content based on the identified causal relations among interactions corresponding to the updated user cluster, which provides a more accurate basis for a targeting of content to the user than the conventional approach of targeting content based on homogeneously identified user clusters.

A method, non-transitory computer readable medium, system, and apparatus for data processing using machine learning are described. At least one aspect of the method, non-transitory computer readable medium, system, and apparatus includes obtaining, by a machine learning model, a user cluster and interaction data for users in the user cluster, wherein the interaction data relates to interactions between the users and a digital platform; generating a directed graph based on the user cluster and the interaction data, wherein the directed graph represents causal relationships among the interactions; updating, by the machine learning model, the user cluster based on the directed graph; and providing, by a content component, customized content to a user via the digital platform based on the updated user cluster.

A method, non-transitory computer readable medium, system, and apparatus for data processing using machine learning are described. At least one aspect of the method, non-transitory computer readable medium, system, and apparatus includes obtaining, by a training component, training data including a user cluster and interaction data for users in the user cluster, wherein the interaction data relates to interactions between the users and a digital platform; training, by the training component, parameters of a machine learning model based on the user cluster and the interaction data, wherein the machine learning model corresponds to a directed graph representing causal relationships among the interactions; updating, by the machine learning model, the user cluster based on the directed graph; and updating, by the training component, the parameters of the machine learning model based on the updated user cluster.

A system and an apparatus for data processing using machine learning are described. At least one aspect of the system and the apparatus includes at least one processor; at least one memory storing instructions executable by the at least one processor; and a machine learning model comprising machine learning parameters stored in the at least one memory component, the machine learning model trained to cluster users by generating a directed graph based on a user cluster and interaction data and updating the user cluster based on the directed graph.

### BRIEF DESCRIPTION OF THE DRAWINGS

FIG. 1 shows an example of a data processing system according to aspects of the present disclosure.

FIG. 2 shows an example of a data processing apparatus according to aspects of the present disclosure.

FIG. 3 shows an example of data flow in a data processing apparatus according to aspects of the present disclosure.

FIG. 4 shows an example of a method for customizing content according to aspects of the present disclosure.

FIG. 5 shows an example of a method for providing customized content according to aspects of the present disclosure.

FIG. 6 shows an example of a process for iteratively updating a user cluster according to aspects of the present disclosure.

FIG. 7 shows an example of an evaluation directed graph for evaluating a performance of a machine learning model according to aspects of the present disclosure.

FIG. 8 shows an example of a directed graph for an interaction dataset according to aspects of the present disclosure.

FIG. 9 shows an example of a first directed graph for the interaction dataset of FIG. 8 according to aspects of the present disclosure.

FIG. 10 shows an example of a second directed graph for the interaction dataset of FIG. 8 according to aspects of the present disclosure.

FIG. 11 shows an example of a third directed graph for the interaction dataset of FIG. 8 according to aspects of the present disclosure.

FIG. 12 shows an example of a fourth directed graph for the interaction dataset of FIG. 8 according to aspects of the present disclosure.

FIG. 13 shows an example of a fifth directed graph for the interaction dataset of FIG. 8 according to aspects of the present disclosure.

FIG. 14 shows an example of a method for training a machine learning model according to aspects of the present disclosure.

### DETAILED DESCRIPTION

User clustering refers to grouping users according to some pattern in data corresponding to the users. Identifying clusters of users is important in a communications context, because the underlaying user data that informs the clustering allows cluster-targeted content to be provided to a user included in a cluster according to a predicted effect that the content will have on the user.

In some cases, clusters of users differ in underlying user attributes, where examples of attributes include actions by an entity toward users (e.g., user exposure to communications from the entity), user actions (e.g., searching, responding to communications, etc.) and/or user characteristics (e.g., time spent by a user on a website, etc.). Some conventional data processing systems and techniques identify homogenous causal relations among attributes for the set of users as a whole. For example, some conventional systems and techniques obtain a union graph over a whole population and use the union graph to identify non-invariant nodes of the union graph (i.e., nodes having same parent nodes across all the mixture components) which are used for k-means clustering to obtain subgroups. Some conventional systems and techniques define a dependence contribution kernel for use in a kernelized k-means algorithm to obtain clusters that are homogenous with respect to an underlying causal structure.

However, causal relations among attributes for the set of users as a whole are unlikely to hold for different subsets of the set of users, because causal relations among attributes for the set of users as a whole do not carry over to causal relations among attributes for the subsets of users of the set of users in some cases. Therefore, a clustering of users based on a homogenous identification of causal relations among user attributes for a set of users as a whole is likely to lead to an inaccurate identification of effective targeting data for at least one of the user clusters.

In some cases, heterogeneity in causal relations among attributes for the subsets of users merits different actions, respectively, for the subsets of users. Therefore, aspects of the present disclosure provide systems and methods for learning cluster-specific causal relations among user interaction data, thereby providing for a more effective targeting of user clusters than conventional data processing systems and techniques.

According to some aspects, a data processing system includes a machine learning model including machine learning parameters stored in at least one memory component, the machine learning model trained to cluster users by generating a directed graph based on a user cluster and interaction data and updating the user cluster based on the directed graph. In some cases, the interaction data relates to interactions between the users and a digital platform. In some cases, the directed graph represents causal relationships among the interactions.

In some cases, by updating the user cluster based on the directed graph representing the causal relations among interactions between the users and the digital platform, the machine learning model recognizes heterogeneity among causal relations of sub-groups of users, where the sub-groups are not defined (e.g., a priori or exogenously) by a similarity in interactions, but are characterized by the causal relations among the interactions. Accordingly, in some cases, the data processing system is able to identify a user interaction that more accurately informs targeted content for achieving a desired outcome for a user cluster than conventional data processing systems and techniques.

In some cases, the data processing system includes a content component configured to provide customized content based on the updated user cluster. For example, in some cases, given at least one target interaction (e.g., an interaction included in the interaction data that is likely to cause the occurrence of another interaction included in the interaction data, such a goal interaction) identified by the updated user cluster, the content component provides content customized according to the target interaction (e.g., content including information that encourages an occurrence or increase in the target interaction) to a user included in the updated user cluster. By encouraging the occurrence or increase in the target interaction, an occurrence of the goal interaction is thereby promoted.

According to some aspects, therefore, the data processing system achieves an improvement in user targeting technology by identifying a more accurate target interaction for a user cluster than conventional user targeting systems and methods are capable of identifying. Furthermore, the increased accuracy of the identified target interaction allows the data processing system to provide more accurate and effective customized content than conventional data processing systems are capable of providing.

As used herein, “interaction data” refers to a data set including data relating to at least one interaction between a user and a digital platform. As used herein, a “digital platform” is a platform that displays digital content, such a website, an app, an email, a social media platform, etc. As used herein, “digital content” refers to information presented on the digital platform, including text information, image or video information, and/or audio information. Examples of user interactions include visiting the digital platform from a different digital platform, visiting specific sections of the digital platform, hyperlink clicks, viewing digital content on the digital platform, adding a product to a cart, purchasing a product, an amount of time spent on a section of the digital platform, etc.

As used herein, a “user cluster” refers to a subset of users of the digital platform (e.g., users for which interaction data exists). As used herein, a “directed graph” refers to a graph including at least two nodes connected by an edge, where the edge indicates a relation between information corresponding to the at least two nodes. As used herein, a “causal relationship” refers to a non-zero degree to which an interaction causes another interaction. As used herein, a “target interaction” refers to an interaction included in the interaction data that is identified to contribute to a causation of another interaction of the interaction data (such as a goal interaction). In some cases, a target interaction is treated as a key performance indicator. As used herein, “customized content” refers to content that is generated, produced, retrieved, or provided on the basis of an interaction included in the interaction data (such as a target interaction).

An embodiment of the present disclosure is used in a communications context. In an example, the data processing system updates a user cluster of a set of users of a digital platform (e.g., a website) according to causal relationships among interactions for the set of users. In an example, the data processing system determines, by updating the user cluster based on a directed graph for the user cluster, that an amount of time that users assigned to the updated user cluster spend visiting the digital platform is influenced by a number of promotions made available to users having a specific operating system installed on their user devices.

Therefore, given a goal interaction of increasing an amount of time spent on the digital platform, the data processing system identifies, based on the updated user cluster, an interaction with the promotions available to users associated with the specific operating system as a target interaction, and therefore provides customized content including additional promotions directed at users of the specific operating system to users included in the updated user cluster. The data processing system therefore is able to customize content for some users of the digital platform in a learned, rather than observed, manner, and is able to provide customized content with a more granular understanding of how to increase time spent on the digital platform than conventional data processing systems provide.

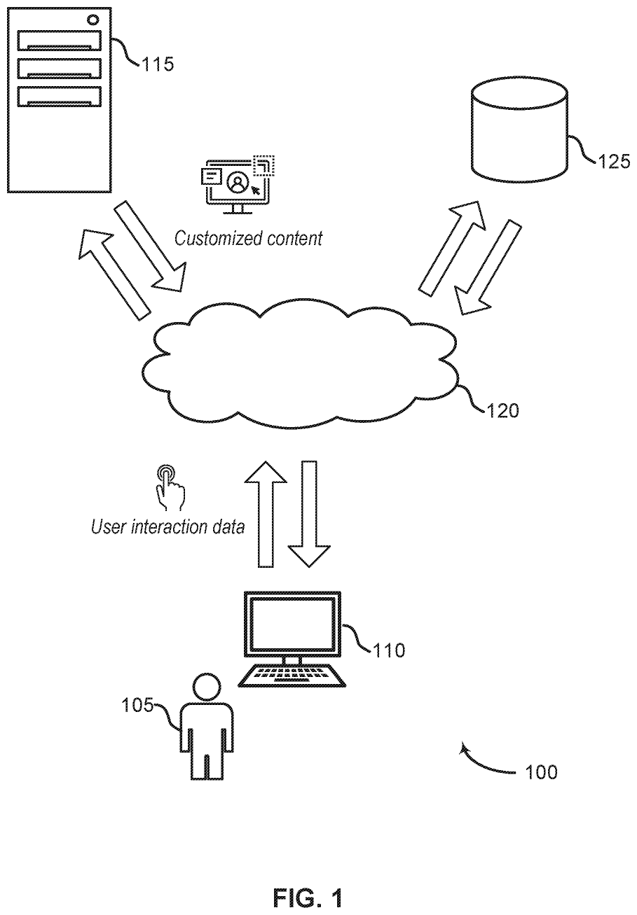

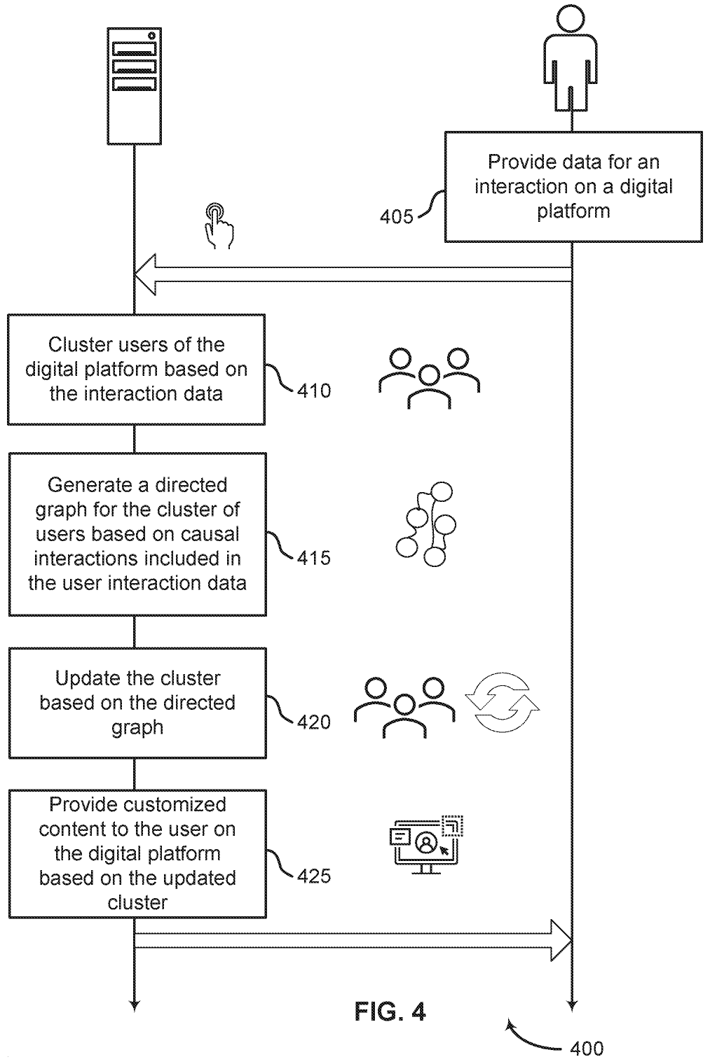

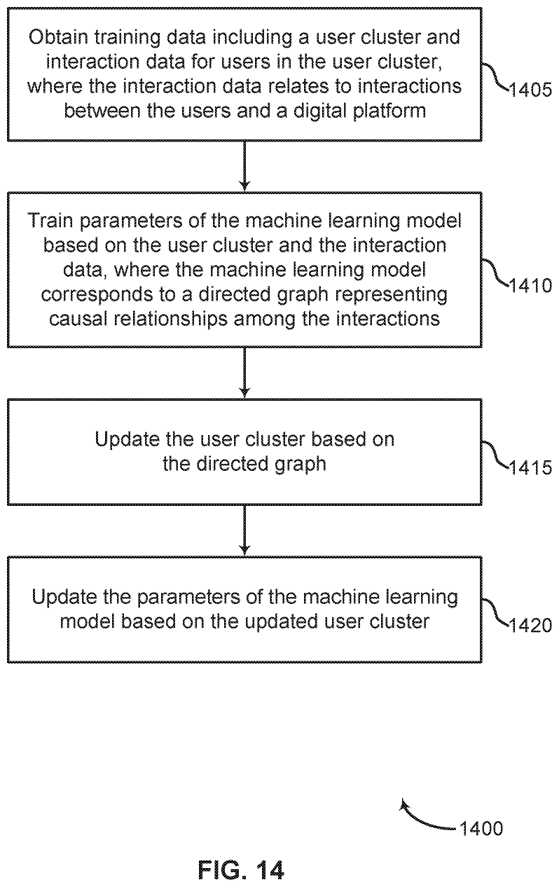

Further example applications of the present disclosure in a communications context are provided with reference to FIGS. 1 and 4. Details regarding the architecture of the data processing system are provided with reference to FIGS. 1-3. Examples of a process for providing customized content are described with reference to FIGS. 4-13. Examples of a process for training a machine learning model are provided with reference to FIG. 14.

### Data Processing System

A system and an apparatus for data processing using machine learning are described with reference to FIGS. 1-3. At least one aspect of the system and the apparatus includes at least one processor; at least one memory storing instructions executable by the at least one processor; and a machine learning model comprising machine learning parameters stored in the at least one memory component, the machine learning model trained to cluster users by generating a directed graph based on a user cluster and interaction data and updating the user cluster based on the directed graph.

Some examples of the system and apparatus further include a monitoring component configured to collect the interaction data for a digital platform. Some examples of the system and apparatus further include a content component configured to generate customized content based on the user cluster. Some examples of the system and apparatus further include a user interface configured to display the customized content. Some examples of the system and apparatus further include a training component configured to update the parameters of the machine learning model.

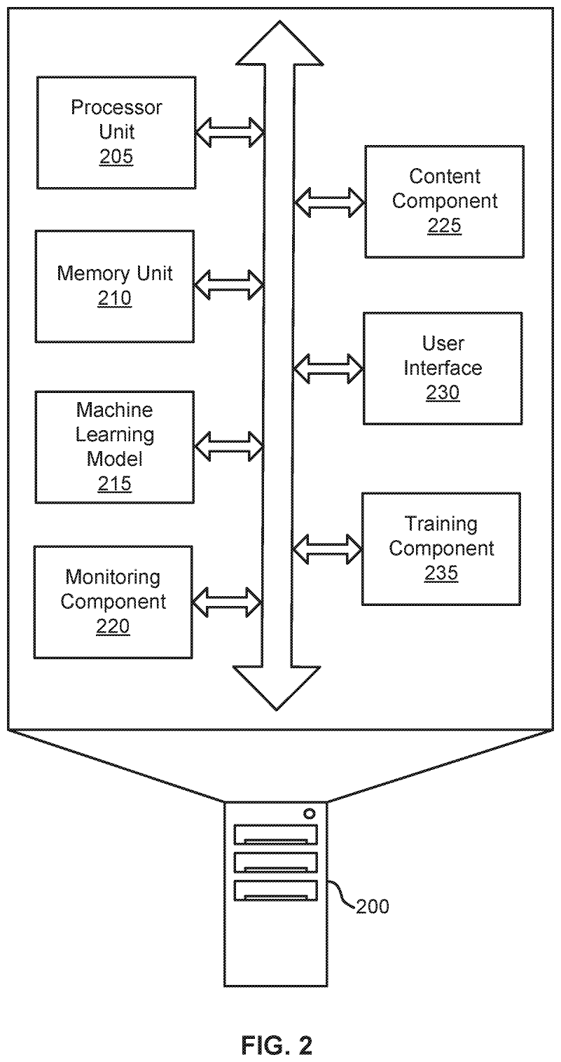

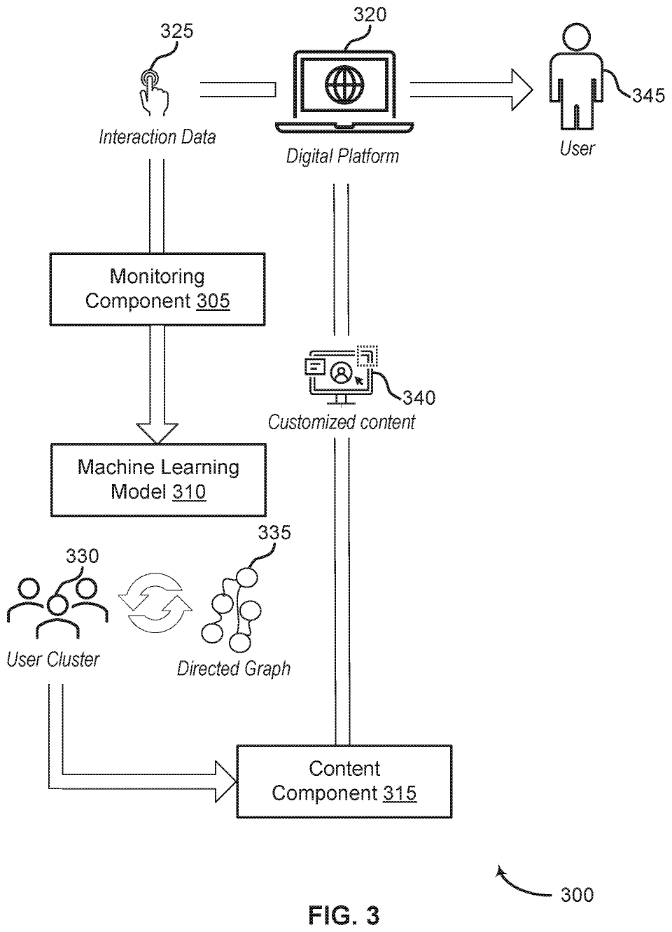

FIG. 1 shows an example of a data processing system 100 according to aspects of the present disclosure. The example shown includes data processing system 100, user 105, user device 110, data processing apparatus 115, cloud 120, and database 125. User 105 is an example of, or includes aspects of, the corresponding element described with reference to FIG. 3. Data processing apparatus 115 is an example of, or includes aspects of, the corresponding element described with reference to FIGS. 2 and 3.

Referring to FIG. 1, user 105 interacts with a digital platform via user device 110. The digital platform provides the user interaction data to data processing apparatus 115. Data processing apparatus 115 generates a user cluster including user 105 based on causal relationships included in the user interaction data and interaction data from other users of the digital platform. Data processing apparatus 115 provides customized content to user 105 via the digital platform and user device 110 based on the assignment of user 105 to the user cluster.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

Data processing apparatus 115 is an example of, or includes aspects of, the corresponding element described with reference to FIGS. 2 and 3. According to some aspects, data processing apparatus 115 includes a computer-implemented network. In some embodiments, the computer-implemented network includes a machine learning model. In some embodiments, data processing apparatus 115 also includes at least one processor, a memory subsystem, a communication interface, an I/O interface, at least one user interface component, and a bus. Additionally, in some embodiments, data processing apparatus 115 communicates with user device 110 and database 125 via cloud 120.

In some cases, data processing apparatus 115 is implemented on a server. A server provides at least one function to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of data processing apparatus 115 is provided with reference to FIGS. 2-3. Further detail regarding a process for providing customized content is provided with reference to FIGS. 4-13. Examples of a process for training a machine learning model are provided with reference to FIG. 14.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to data processing apparatus 115 and communicates with data processing apparatus 115 via cloud 120. According to some aspects, database 125 is included in data processing apparatus 115.

FIG. 2 shows an example of a data processing apparatus 200 according to aspects of the present disclosure. Data processing apparatus 200 is an example of, or includes aspects of, the corresponding element described with reference to FIGS. 1 and 3. In one aspect, data processing apparatus 200 includes processor unit 205, memory unit 210, machine learning model 215, monitoring component 220, content component 225, user interface 230, and training component 235.

Processor unit 205 includes at least one processor. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing.

Memory unit 210 includes at least one memory device. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 205 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, in some cases, the memory controller includes a row decoder, column decoder, or both. In some cases, memory cells within memory unit 210 store information in the form of a logical state.

Machine learning model 215 is an example of, or includes aspects of, the corresponding element described with reference to FIG. 3. According to some aspects, machine learning model 215 is implemented as software stored in memory unit 210 and executable by processor unit 205, as firmware, as at least one hardware circuit, or as a combination thereof. According to some aspects, machine learning model 215 comprises machine learning parameters stored in memory unit 210.

Machine learning parameters, also known as model parameters or weights, are variables that provide a behavior and characteristics of a machine learning model. In some cases, machine learning parameters are learned or estimated from training data and are used to make predictions or perform tasks based on learned patterns and relationships in the data.

In some cases, machine learning parameters are adjusted during a training process to minimize a loss function or maximize a performance metric. In some cases, a goal of the training process is to find optimal values for the parameters that allow the machine learning model to make accurate predictions or perform well on the given task.

For example, in some cases, during the training process, an algorithm adjusts machine learning parameters to minimize an error or loss between predicted outputs and actual targets according to optimization techniques like gradient descent, stochastic gradient descent, or other optimization algorithms. In some cases, once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the ANN's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes.

In some cases, the signals between nodes comprise real numbers, and the output of each node is computed by a function of the sum of the inputs of each node. In some examples, nodes determine the output using other mathematical algorithms, such as selecting the max from the inputs as the output, or any other suitable algorithm for activating the node. In some cases, each node and edge are associated with at least one node weight that determines how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to increase the accuracy of the result (e.g., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some cases, machine learning model 215 comprises at least one ANN trained to cluster users by generating a directed graph based on a user cluster and interaction data and updating the user cluster based on the directed graph.

According to some aspects, machine learning model 215 obtains a user cluster and interaction data for users in the user cluster, where the interaction data relates to interactions between the users and a digital platform. In some examples, machine learning model 215 generates a directed graph based on the user cluster and the interaction data, where the directed graph represents causal relationships among the interactions. In some examples, machine learning model 215 updates the user cluster based on the directed graph.

In some examples, machine learning model 215 obtains a set of user clusters, where the interaction data relates to interactions from the set of user clusters. In some examples, machine learning model 215 generates a set of directed graphs corresponding to the set of user clusters. In some examples, machine learning model 215 updates the set of user clusters based on the set of directed graphs.

In some examples, obtaining the user cluster includes randomly assigning the users to the user cluster. In some examples, obtaining the user cluster includes assigning the users to the user cluster based on the interaction data. In some examples, generating the directed graph includes learning edges and weights of the directed graph. In some examples, updating the user cluster includes calculating a likelihood of a user being assigned to the user cluster based on the directed graph. In some examples, machine learning model 215 iteratively updates the user cluster and the directed graph.

In some examples, machine learning model 215 obtains training data by randomly assigning the users to a user cluster. In some examples, machine learning model 215 obtains training data by assigning users to a user cluster based on interaction data. In some examples, machine learning model 215 learns edges and weights of a directed graph.

In some cases, machine learning model 215 comprises a feedforward network. In some cases, a feedforward network is an ANN characterized by a forward, unidirectional flow of information between layers of the ANN.

In some cases, machine learning model 215 comprises a recurrent neural network (RNN). An RNN is a class of ANN in which connections between nodes form a directed graph along an ordered (i.e., a temporal) sequence, enabling the RNN to model temporally dynamic behavior such as predicting what element should come next in a sequence. Thus, an RNN is suitable for tasks that involve ordered sequences such as text recognition (where words are ordered in a sentence). In some cases, the term RNN includes finite impulse recurrent networks (characterized by nodes forming a directed acyclic graph) and/or infinite impulse recurrent networks (characterized by nodes forming a directed cyclic graph).

Monitoring component 220 is an example of, or includes aspects of, the corresponding element described with reference to FIG. 3. According to some aspects, monitoring component 220 is implemented as software stored in memory unit 210 and executable by processor unit 205, as firmware, as at least one hardware circuit, or as a combination thereof. According to some aspects, monitoring component 220 is configured to collect the interaction data for a digital platform.

Content component 225 is an example of, or includes aspects of, the corresponding element described with reference to FIG. 3. According to some aspects, content component 225 is implemented as software stored in memory unit 210 and executable by processor unit 205, as firmware, as at least one hardware circuit, or as a combination thereof. According to some aspects, content component 225 provides customized content to a user via the digital platform based on the updated user cluster. In some examples, content component 225 selects a target interaction for the user based on the user cluster, where the customized content is provided based on the target interaction. According to some aspects, content component 225 is configured to generate customized content based on the user cluster. According to some aspects, content component 225 comprises content generation parameters (e.g., machine learning parameters) stored in memory unit 210. According to some aspects, content component 225 comprises a generative machine learning model (such as a diffusion model, a large language model, etc.) trained to generate the customized content based on the user cluster.

According to some aspects, user interface 230 is configured to display the customized content. According to some aspects, user interface 230 is implemented as software stored in memory unit 210 and executable by processor unit 205. According to some aspects, user interface 230 is a graphical user interface (GUI) provided on a user device (such as the user device described with reference to FIG. 1) by data processing apparatus 200.

According to some aspects, training component 235 is implemented as software stored in memory unit 210 and executable by processor unit 205, as firmware, as at least one hardware circuit, or as a combination thereof. In some cases, training component 235 is omitted from data processing apparatus 200. In some cases, training component 235 is included in a separate apparatus from data processing apparatus 200 and communicates with data processing apparatus 200 to perform the training functions described herein. In some cases, training component 235 is implemented as software stored in a memory unit of the separate apparatus and executable by a processor unit of the separate apparatus, as firmware of the separate apparatus, as at least one hardware circuit of the separate apparatus, or as a combination thereof.

According to some aspects, training component 235 is configured to update the parameters of machine learning model 215. According to some aspects, training component 235 obtains training data including a user cluster and interaction data for users in the user cluster, where the interaction data relates to interactions between the users and a digital platform. In some examples, training component 235 trains parameters of machine learning model 215 based on the user cluster and the interaction data, where machine learning model 215 corresponds to a directed graph representing causal relationships among the interactions. In some examples, training component 235 updates the parameters of machine learning model 215 based on the updated user cluster.

FIG. 3 shows an example of data flow in a data processing apparatus 300 according to aspects of the present disclosure. The example shown includes data processing apparatus 300, digital platform 320, interaction data 325, user cluster 330, directed graph 335, customized content 340, and user 345.

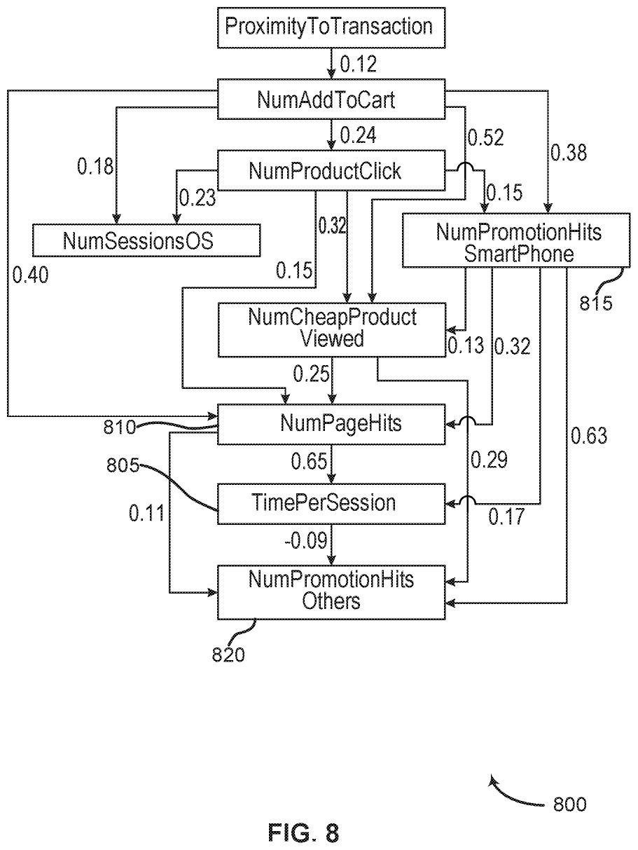

Data processing apparatus 300 is an example of, or includes aspects of, the corresponding element described with reference to FIGS. 1 and 2. In one aspect, data processing apparatus 300 includes monitoring component 305, machine learning model 310, and content component 315. Monitoring component 305, machine learning model 310, and content component 315 are examples of, or include aspects of, the corresponding elements described with reference to FIG. 2. Directed graph 335 is an example of, or includes aspects of, the corresponding element described with reference to FIGS. 8-13. User 345 is an example of, or includes aspects of, the corresponding element described with reference to FIG. 1.

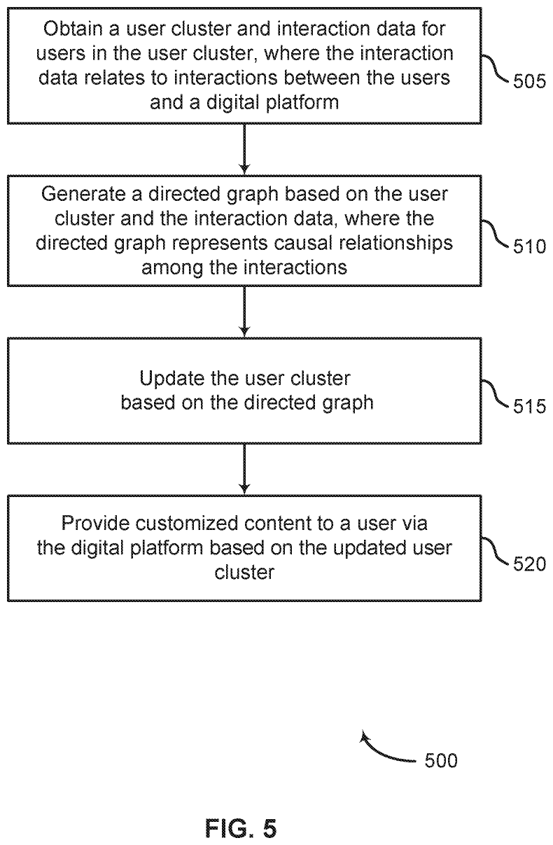

Referring to FIG. 3, according to some aspects, monitoring component 305 retrieves interaction data 325 from digital platform 320 and provides interaction data 325 to machine learning model 310 (for example, as described with reference to FIG. 5). In some cases, machine learning model 310 obtains user cluster 330 based on interaction data 325 (for example, as described with reference to FIG. 5), iteratively updates user cluster 330 based on directed graph 335, and iteratively updates directed graph 335 based on user cluster 330 (for example, as described with reference to FIG. 5). In some cases, content component 315 obtains updated user cluster 330 and provides customized content 340 to user 345 via digital platform 320 based on updated user cluster 330 (for example, as described with reference to FIG. 5).

### Data Processing

A method for data processing using machine learning is described with reference to FIGS. 4-13. At least one aspect of the method includes obtaining a user cluster and interaction data for users in the user cluster, wherein the interaction data relates to interactions between the users and a digital platform; generating a directed graph based on the user cluster and the interaction data, wherein the directed graph represents causal relationships among the interactions; updating the user cluster based on the directed graph; and providing customized content to a user via the digital platform based on the updated user cluster.

Some examples of the method further include obtaining a plurality of user clusters, wherein the interaction data relates to interactions from the plurality of user clusters. Some examples further include generating a plurality of directed graphs corresponding to the plurality of user clusters. Some examples further include updating the plurality of user clusters based on the plurality of directed graphs.

In some examples of the method, obtaining the user cluster comprises randomly assigning the users to the user cluster. In some examples of the method, obtaining the user cluster comprises assigning the users to the user cluster based on the interaction data.

In some examples of the method, generating the directed graph comprises learning edges and weights of the directed graph. In some examples of the method, updating the user cluster comprises calculating a likelihood of a user being assigned to the user cluster based on the directed graph.

Some examples of the method further include iteratively updating the user cluster and the directed graph. Some examples of the method further include selecting a target interaction for the user based on the user cluster, wherein the customized content is provided based on the target interaction.

FIG. 4 shows an example of a method 400 for customizing content according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 4, an embodiment of the present disclosure is used in a communications context. In an example, a data processing system (such as the data processing system described with reference to FIG. 1) updates a user cluster of a set of users of a digital platform (e.g., a website) according to causal relationships among interactions for the set of users. In an example, the data processing system determines, by updating the user cluster based on a directed graph for the user cluster, that an amount of time that users assigned to the updated user cluster spend visiting the digital platform is influenced by a number of promotions made available to users having a specific operating system installed on their user devices.

Therefore, given a goal interaction of increasing an amount of time spent on the digital platform, the data processing system identifies, based on the updated user cluster, an interaction with the promotions available to users associated with the specific operating system as a target interaction, and therefore provides customized content including additional promotions directed at users of the specific operating system to users included in the updated user cluster. The data processing system therefore is able to customize content for some users of the digital platform in a learned, rather than observed, manner, and is able to provide customized content with a more granular understanding of how to increase time spent on the digital platform than conventional data processing systems provide. Furthermore, unlike conventional data processing systems and techniques, some embodiments of the present disclosure simultaneously clusters the set of users and learns directed graphs for the user clusters.

At operation 405, a user provides data for an interaction on a digital platform. In some cases, the operations of this step refer to, or are performed by, a user as described with reference to FIGS. 1 and 3. For example, the user interacts with a digital platform via a user device (such as the user device described with reference to FIG. 1), and the digital platform provides interaction data relating to the user and the interaction to a data processing apparatus (such as the data processing apparatus described with reference to FIGS. 1-3). In some cases, a monitoring component (such as the monitoring component described with reference to FIGS. 2-3) obtains the user interaction data by monitoring the digital platform.

At operation 410, the system clusters users of the digital platform based on the interaction data. In some cases, the operations of this step refer to, or are performed by, a data processing apparatus as described with reference to FIG. 1. For example, according to some aspects, the data processing apparatus clusters the users as described with reference to FIG. 5.

At operation 415, the system generates a directed graph for the cluster of users based on causal interactions included in the user interaction data. In some cases, the operations of this step refer to, or are performed by, a data processing apparatus as described with reference to FIG. 1. For example, according to some aspects, the data processing apparatus generates the directed graph as described with reference to FIG. 5.

At operation 420, the system updates the cluster based on the directed graph. In some cases, the operations of this step refer to, or are performed by, a data processing apparatus as described with reference to FIG. 1. For example, according to some aspects, the data processing apparatus updates the cluster as described with reference to FIG. 5.

At operation 425, the system provides customized content to the user on the digital platform based on the updated cluster. In some cases, the operations of this step refer to, or are performed by, a data processing apparatus as described with reference to FIG. 1. For example, according to some aspects, the data processing apparatus provides the customized content as described with reference to FIG. 5.

FIG. 5 shows an example of a method 500 for dating according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, according to some aspects, a data processing system uses a machine learning model to cluster users by generating a directed graph based on a user cluster and interaction data and updating the user cluster based on the directed graph. In some cases, the interaction data relates to interactions between the users and a digital platform. In some cases, the directed graph represents causal relationships among the interactions.

In some cases, by updating the user cluster based on the directed graph representing the causal relations among interactions between the users and the digital platform, the machine learning model recognizes heterogeneity among causal relations of sub-groups of users, where the sub-groups are not defined (e.g., a priori or exogenously) by a similarity in interactions, but are characterized by the causal relations among the interactions. Accordingly, in some cases, the data processing system is able to identify a more accurate a target interaction for the user cluster based on causal relations among the interaction data than conventional data processing systems and techniques provide.

In some cases, the data processing system includes a content component configured to provide customized content based on the updated user cluster. For example, in some cases, given at least one target interaction (e.g., an interaction included in the interaction data that is likely to cause the occurrence of another interaction included in the interaction data, such a goal interaction) identified by the updated user cluster, the content component provides content customized according to the target interaction (e.g., content including information that encourages an occurrence or increase in the target interaction) to a user included in the updated user cluster. By encouraging the occurrence or increase in the target interaction, an occurrence of the goal interaction is promoted.

According to some aspects, therefore, the data processing system achieves an improvement in user targeting technology by identifying a more accurate target interaction for a user cluster than conventional user targeting systems and methods are capable of identifying. Furthermore, the increased accuracy of the identified target interaction allows the data processing system to provide more accurate and effective customized content than conventional data processing systems are capable of providing.

As used herein, “interaction data” refers to a data set including data relating to at least one interaction between a user and a digital platform. As used herein, a “digital platform” is a platform that displays digital content, such a website, an app, an email, etc. As used herein, “digital content” refers to information presented on the digital platform, including text information, image or video information, and/or audio information. Examples of user interactions include visiting the digital platform from a different digital platform, visiting specific sections of the digital platform, hyperlink clicks, viewing digital content on the digital platform, adding a product to a cart, purchasing a product, an amount of time spent on a section of the digital platform, etc.

As used herein, a “user cluster” refers to a subset of users of the digital platform (e.g., users for which interaction data exists). As used herein, a “directed graph” refers to a graph including at least two nodes connected by an edge, where the edge indicates a relation between information corresponding to the at least two nodes. As used herein, a “causal relationship” refers to a non-zero degree to which an interaction causes another interaction. As used herein, a “target interaction” refers to an interaction included in the interaction data that is identified to contribute to a causation of another interaction of the interaction data (such as a goal interaction). In some cases, a target interaction is treated as a key performance indicator. As used herein, “customized content” refers to content that is generated, produced, retrieved, or provided on the basis of an interaction included in the interaction data (such as a target interaction).

At operation 505, the system obtains a user cluster and interaction data for users in the user cluster, where the interaction data relates to interactions between the users and a digital platform. In some cases, the operations of this step refer to, or are performed by, a machine learning model as described with reference to FIGS. 2 and 3.

According to some aspects, a monitoring component (such as the monitoring component described with reference to FIGS. 2-3) of a data processing apparatus (such as the data processing apparatus described with reference to FIGS. 1-3) collects the interaction data from the digital platform. For example, in some cases, the monitoring component accesses the digital platform (e.g., via an API call, a script embedded in the digital platform, etc.) and retrieves the interaction data from the accessed digital platform. In some cases, interaction data is associated with a user of the digital platform via a user identifier (such as a cookie, a device fingerprint, a pixel, etc.). In some cases, the monitoring component stores the interaction data in a database (such as the database described with reference to FIG. 1). In some cases, the monitoring component respectively associates each item of interaction data with a corresponding user. In some cases, the monitoring component stores data indicative of the association in the database.

According to some aspects, the interaction data relates to interactions between the users and a digital platform, such as actions taken on the digital platform (e.g., previous platforms visited, pages visited, hyperlinks clicked, digital content viewed, products added to a cart, purchases made, etc.), sequences of actions taken on the digital platform, and/or time spent on the platform (e.g., an amount of time viewing digital content, pages, carts, a time elapsed during a session on the digital platform, etc.).

Examples of interaction data, or in other words user attributes, include an amount of time between a user action on the digital platform and a transaction by the user on the digital platform (ProximityToTransaction), a number of products added to a shopping cart by the user (NumAddToCart), a number of products clicked on by the user (NumProductClick), a number of times the user visited the digital platform using a particular operating system (NumSessionsOS), a number of times the user clicked on a promotion while using a particular smart phone (NumPromotionHitsSmartPhone), a number of times the user clicked on a promotion while using something other than the particular smart phone (NumPromotionHitsOthers), a number of times a user viewed a product having a price under a particular price threshold (NumCheapProductViewed), a number of times a user clicked on a particular page of the digital platform (NumPageHits), and an amount of time spent by the user on the digital platform during a session (TimePerSession).

According to some aspects, the monitoring component provides the interaction data to the machine learning model. In some cases, the interaction data is an m×n data matrix X (m<<n), where each column in the data matrix X corresponds to an interaction of the interaction data, each row in the data matrix X corresponds to a user, and each entry in the data matrix X corresponds to a value for a corresponding user and interaction. In some cases, the machine learning model obtains the user cluster by randomly assigning users corresponding to the interaction data to the user cluster. In some cases, the machine learning model obtains the user cluster by assigning users corresponding to the interaction data to the user cluster based on the interaction data. For example, in some cases, the machine learning model assigns users to the user clusters based on at least one similarity in the interaction data corresponding to the users.

In some cases, the machine learning model obtains a set of user clusters by randomly assigning users corresponding to the interaction data to user clusters of the set of user clusters. In some cases, the machine learning model obtains a set of user clusters by assigning users corresponding to the interaction data to user clusters of the set of user clusters based on the interaction data. For example, in some cases, the machine learning model assigns users to user clusters of the set of user clusters based on at least one similarity in the interaction data corresponding to the users. In some cases, the number of user clusters is predetermined.

At operation 510, the system generates a directed graph based on the user cluster and the interaction data, where the directed graph represents causal relationships among the interactions. In some cases, the operations of this step refer to, or are performed by, a machine learning model as described with reference to FIGS. 2 and 3. According to some aspects, the machine learning model generates a set of directed graph for the set of user clusters, where each directed graph of the set of directed graphs is generated for a corresponding user cluster of the set of user clusters.

According to some aspects, each node of the directed graph is a representation of an interaction in the interaction data, and each edge is a representation of a weight, or a degree to which one interaction (represented by a first node contacting the edge) causes another interaction (represented by a second node contacting the edge). In some cases, the weight is referred to as a connection strength.

According to some aspects, the machine learning model learns edges and weights of the directed graph. For example, in some cases, the machine learning model learns a directed graph including the edges and weights of the directed graph based on the interaction data.

In some cases, the interactions xᵢ of the interaction data are arrangeable in a causal order k(i), such that no later interactions cause any earlier interactions, and the interaction data is therefore representable by at least one directed acyclic graph (DAG). In some cases, a value for each interaction xᵢ is a linear function of values already assigned to earlier interactions, plus a noise term et, plus an optional constant term cᵢ:xᵢ=Σ_{k(j)<k(i)}bᵢⱼxⱼ+eᵢ+cᵢ, where the noise terms e; are each continuous-valued random variables with non-Gaussian distributions of non-zero variances, and are independent of each other; e.g., p(e₁, . . . , eₘ)=Πᵢpᵢ(eᵢ). In some cases, the noise terms e; have Gaussian distributions.

In some cases, the interactions xᵢ are linear functions of the noise terms et. Subtracting out a mean of each interaction xᵢ provides x=Bx+e, where B is a matrix that can be permutated to strictly lower triangularity given the causal ordering k(i). Solving for x provides x=Ae, where A=(I−B)⁻¹. In some cases, x=Ae and the independence and non-Gaussian distribution of e provides a standard linear independent component analysis (ICA) model, which is a statistical model used for identifying a linear model.

In some cases, given the data matrix X for the interaction data, the machine learning model subtracts the mean from each row of the data matrix X and applies an ICA algorithm to obtain a decomposition the data matrix X=AS, where S has a same size as X and includes rows including independent components.

In some cases, the machine learning model finds a permutation of rows of W=A⁻¹ that yields a matrix \tilde{W} in which zeros are omitted on the main diagonal. In some cases, the permutation minimizes Σᵢ1/\tilde{W}ᵢᵢ. In some cases, the machine learning model divides each row of \tilde{W} by a corresponding diagonal element to obtain an additional matrix \tilde{W}′ including ones on the diagonal. In some cases, the machine learning model computes an estimate \tilde{B}=I−\tilde{W}′ of B. In some cases, the machine learning model finds the causal order k(i) by finding a permutation matrix P applied equally to rows and columns of \tilde{B} that yields a matrix \tilde{B}=P\tilde{B}P^{T} approximating a strictly lower triangular. In some cases, the causal ordering k(i) provides the edges and the weights of the edges of the directed graph. In some cases, the machine learning model outputs a visual representation of the directed graph. A visual representation of a directed graph corresponding to a set of users is described with reference to FIG. 8.

At operation 515, the system updates the user cluster based on the directed graph. In some cases, the operations of this step refer to, or are performed by, a machine learning model as described with reference to FIGS. 2 and 3. According to some aspects, the machine learning model updates the set of user clusters based on corresponding directed graphs of the set of directed graphs.

According to some aspects, updating the user cluster includes calculating a likelihood of a user being assigned to the user cluster based on the directed graph. For example, in some cases, given a directed graph (e.g., a DAG) G including vertices (e.g., nodes) V=(X₁, X₂, . . . , X_{d}), and with a set of all parents (e.g., earlier nodes connected to later nodes, in terms of causal order, by an edge) of Xⱼ denoted by πₓ_{ⱼ} or π (Xⱼ), and where P is a distribution for V with probability function p(x), P is Markov to G (e.g., G represents P) if:

$$p ( x ) = {\prod }_{j = 1}^{d} p ( {x}_{j} \vert {π}_{{x}_{j}} ) \qquad ( 1 )$$

In some cases, for a given user corresponding to a feature vector v, a likelihood that the feature vector (e.g., a sample) was generated by G having a probability distribution function given by p is:

$$p ( x = v ) = {\prod }_{j = 1}^{d} p ( {x}_{i} = {v}_{i} \vert {π}_{{x}_{i}} ) \qquad ( 2 )$$

In some cases, the machine learning model assumes that the features of the graph G are Gaussian. For example, in some cases, if Tx; is an empty set, then xᵢ˜N(μᵢ, σᵢ), and if πₓ_{ᵢ} is a non-empty set, then xᵢ−w^{T}·πₓ_{ᵢ}˜N(μᵢ, σᵢ). In some cases, p(xᵢ=vᵢ|πₓ_{ᵢ})=p(xᵢ=vᵢ) where πₓ_{ᵢ} is an empty set, and the machine learning model calculates p(xᵢ=vᵢ) by fitting a normal distribution over xᵢ to obtain the mean μᵢ and the standard deviation σᵢ, and uses the mean μᵢ and the standard deviation σᵢ to calculate values of a density function at vᵢ. In some cases, p(xᵢ=vᵢ|πₓ_{ᵢ})=p(xᵢ−w^{T}·πₓ_{ᵢ}=vᵢ−w^{T}·πᵥ_{ᵢ}) where πₓ_{ᵢ} is a non-empty set, and the machine learning model assumes xᵢ−w^{T}·πₓ_{ᵢ} to be normally distributed and fits a normal distribution to calculate values of a density function at vᵢ. In some cases, the machine learning model reassigns a user to a cluster for which the user has a highest likelihood value (for example, as determined by the density function at vᵢ). In some cases, therefore, a user assigned to a first cluster of the set of clusters is reassigned to a second cluster of the set of clusters.

According to some aspects, the machine learning model iteratively updates the user cluster and the directed graph. For example, in some cases, after reassigning users to user clusters, the machine learning model updates the directed graph for each cluster based on the new assignment of the users to the user clusters. According to some aspects, the machine learning model repeats this process until no difference in cluster assignment is observed with respect to previous cluster assignments.

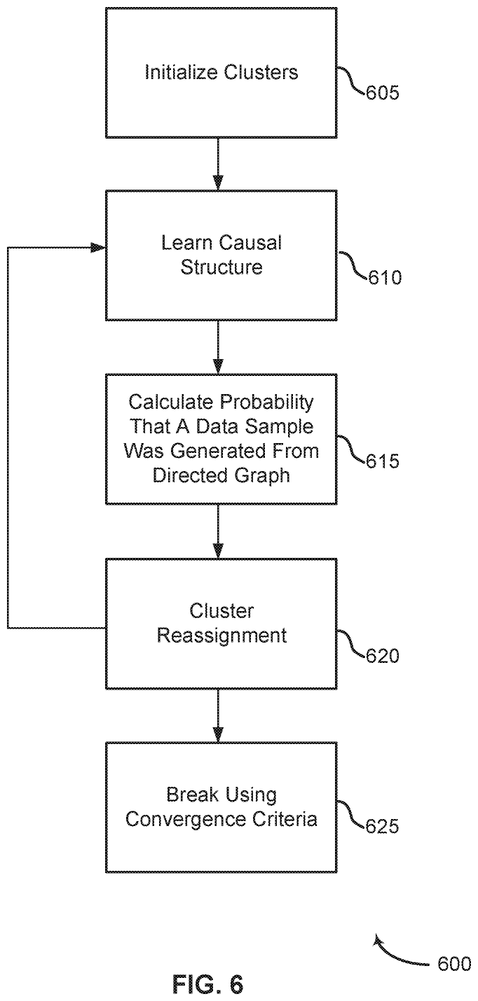

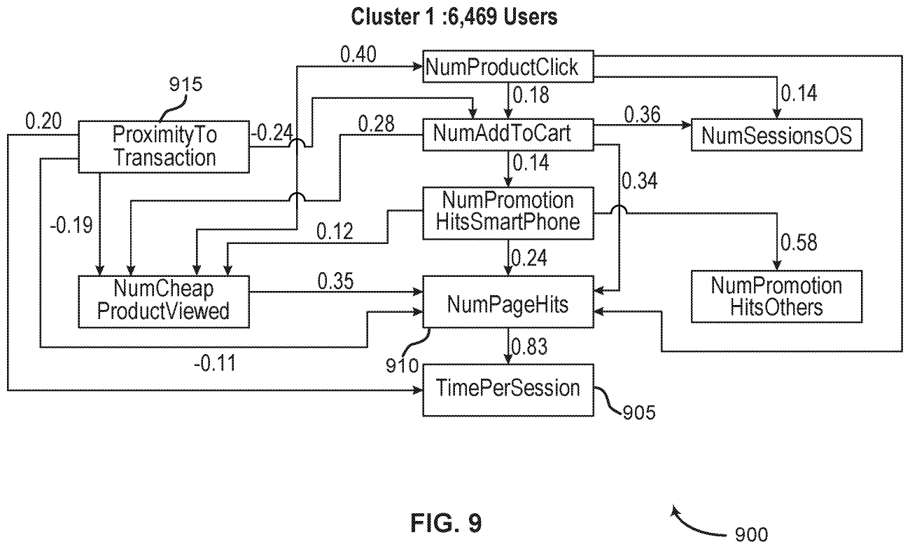

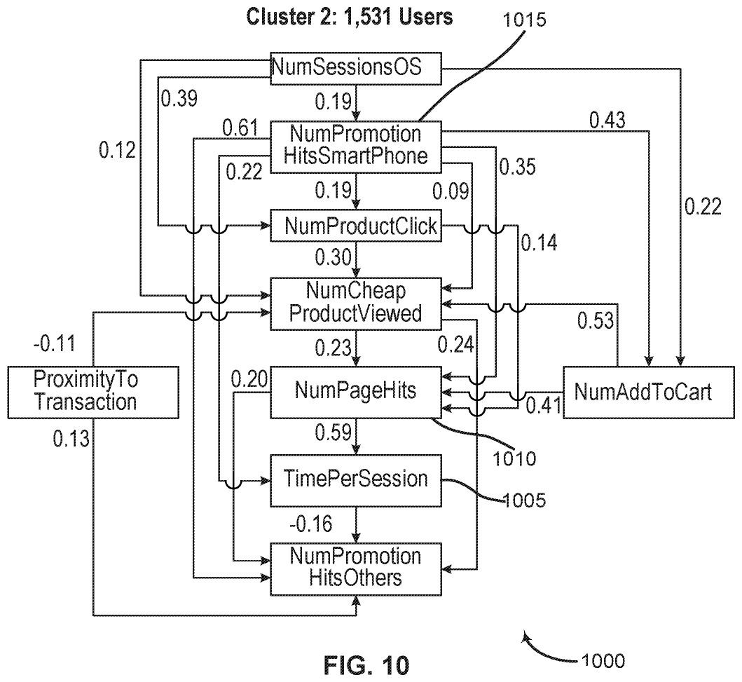

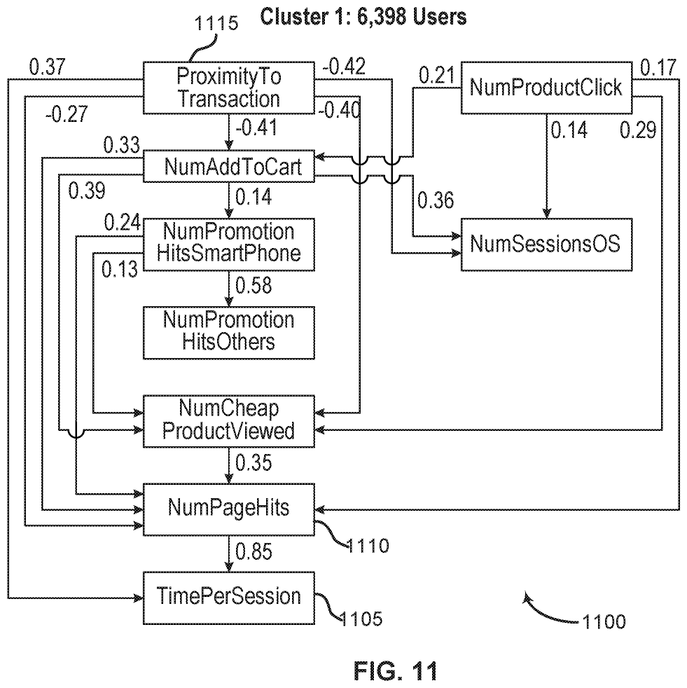

A process of iteratively updating the user cluster and the directed graph is shown with respect to FIG. 6. A visual representation of two directed graphs corresponding to two user clusters determined for the set of users of FIG. 8 are described with reference to FIGS. 9 and 10. A visual representation of three directed graphs corresponding to three user clusters determined for the set of users of FIG. 8 are described with reference to FIGS. 11-13.

Accordingly, aspects of the present disclosure provide at least one user cluster where users of a digital platform are clustered according to causal relations between at least two interactions on the digital platform. Therefore, in some cases, the at least one user cluster provides learned, rather than observed, information about how members of the cluster interact with the digital platform, and the provided information is used to more accurately inform actions (such as providing targeted content) that ought be taken with respect to the digital platform to further a goal of the digital platform (such as encouraging a purchase on the digital platform, or increasing time spent on the digital platform) than conventional data processing systems provide.

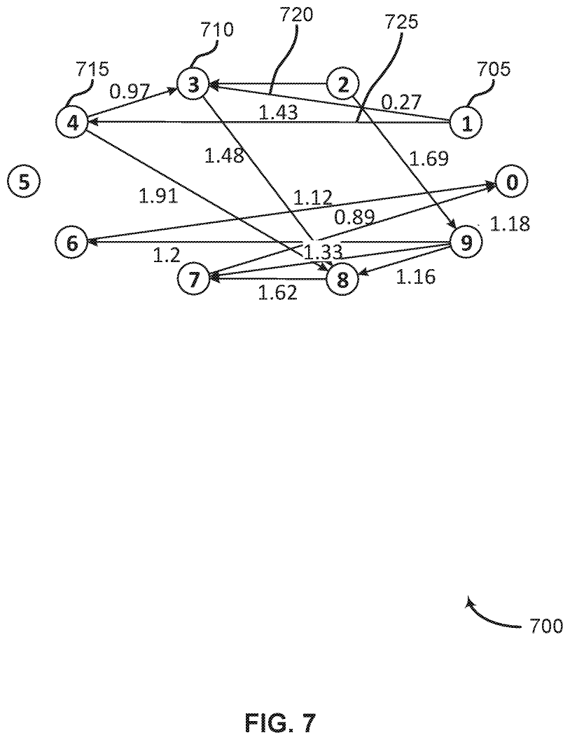

According to some aspects, the machine learning model creates samples for evaluating the machine learning model as described with reference to FIG. 7. According to some aspects, the machine learning model is trained as described with reference to FIG. 14.

At operation 520, the system provides customized content to a user via the digital platform based on the updated user cluster. In some cases, the operations of this step refer to, or are performed by, a content component as described with reference to FIGS. 2 and 3. According to some aspects, the content is “customized” because it is targeted at a user of a particular user cluster by including information that is pertinent to the user cluster (and therefore to the user).

According to some aspects, a content component of the data processing apparatus (such as the content component described with reference to FIGS. 2-3) selects at least one target interaction for the user based on the user cluster. In some cases, the content component retrieves a goal interaction from a database (such as the database described with reference to FIG. 1). In some cases, the at least one target interaction and the goal interaction are interactions included in the interaction data. In some cases, the at least one target interaction is an interaction of the interaction data that is likely to cause the goal interaction in the user cluster.

In an example, a goal interaction is an amount of time spent on the digital platform, and users of the digital platform are assigned to two user clusters. For users of a first user cluster, a directed graph for the first user cluster indicates that a proximity to a transaction and a number of page hits are likely to cause an increased amount of time spent on the digital platform, and therefore a proximity to a transaction and a number of page hits are target interactions for the goal interaction. For users of the second cluster, a directed graph for the second user cluster indicates that a proximity to a number of promotion hits on a smart phone and a number of page hits are likely to cause an increased amount of time spent on the digital platform, and therefore a number of promotion hits on the smart phone and a number of page hits are target interactions for the goal interaction.

According to some aspects, the content component provides the customized content to the user based on the target interaction. For example, in some cases, given at least one target interaction for a user cluster including the user, the content component requests digital content (for example, from a database as described with reference to FIG. 1, or another system or apparatus) corresponding to the at least one target interaction, or generates digital content (for example, using at least one generative machine learning model) corresponding to the at least one target interaction. In an example, given the two target interactions of a proximity to a transaction and a number of page hits for the first user cluster, and an assignment of the user to the first user cluster, the content component retrieves or generates digital content corresponding to at least one of a proximity to a transaction and a number of page hits (for example, content digital content encouraging a transaction, page hits, or a combination thereof). According to some aspects, the content component displays the customized content to the user on the digital platform. In some cases, the content component displays the customized content on the digital platform via a user interface (such as the user interface described with reference to FIG. 2) displayed by the data processing apparatus on a user device (such as the user device described with reference to FIG. 1).

FIG. 6 shows a process 600 for iteratively updating a user cluster according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, at operation 605, a machine learning model (such as the machine learning model described with reference to FIGS. 2-3) initializes a set of user clusters. In an example, the machine learning model initializes the set of user clusters as described with reference to FIG. 5.

At operation 610, the machine learning model learns a causal structure of the set of user clusters. In an example, the machine learning model learns the causal structure for the set of user clusters via a set of directed graphs as described with reference to FIG. 5.

At operation 615, the machine learning model calculates a probability that a data sample (e.g., a user) was generated from a directed graph of the set of directed graphs. In an example, the machine learning model calculates the likelihood based on the set of directed graphs as described with reference to FIG. 5.

At operation 620, the machine learning model reassigns users to clusters to which the users have a highest likelihood of being assigned based on the directed graph. In an example, the machine learning model reassigns the users as described with reference to FIG. 5.

The machine learning model repeats operations 610 through 615 until operation 620, break using convergence criteria, is performed. In an example, the convergence criteria is a lack of change in membership of an iteration of the set of user clusters from a previous iteration of the set of user clusters.

FIG. 7 shows an example of an evaluation directed graph 700 for evaluating a machine learning model according to aspects of the present disclosure. The example shown includes first node 705, third node 710, fourth node 715, first edge 720, and second edge 725.

Referring to FIG. 7, in some cases, a machine learning model (such as the machine learning model described with reference to FIGS. 2-3) generates an evaluation directed graph and an evaluation user cluster for evaluating the machine learning model.

According to some aspects, the machine learning model constructs at least one evaluation directed graph (e.g., a DAG, such as evaluation directed graph 700 including first node 705 connected to third node 710 by first edge 720 and to fourth node 715 by second edge 725) based on user interaction data for obtaining at least one evaluation user cluster, respectively. In some cases, at least two of the evaluation directed graphs include variations in at least one of node connection, node connection density, and edge weights from each other. In some cases, each evaluation directed graph corresponds to an adjacency matrix. In some cases, each evaluation directed graph includes n nodes, where n is a positive integer.

According to some aspects, the machine learning model draws a random sample of size n vector from an evaluation directed graph to create one data observation. In some cases, to obtain an evaluation user cluster from an evaluation directed graph, the machine learning model goes over the nodes of the evaluation directed graph in a topological order. If a node v does not have any parents, the machine learning model assigns a value of the node v to be a random sample from the distribution N(μ, σ). If a node v has parents πᵥ, the machine learning model assigns the value of the node v to be w^{T}·V(πᵥ)+r, where r is a random sample from the distribution N(μ, σ), wᵢ is an edge weight of edge πᵥ→v, and V(πᵥ) is the vector representing the values of nodes in πᵥ, providing a random sample of n dimensions. According to some aspects, the machine learning model repeats the process until a number of observations are created for each cluster, corresponding to each directed graph.

According to some aspects, a performance of the machine learning model is evaluated by using the machine learning model to attempt to recover each of the evaluation user clusters by generating a corresponding number of user clusters based on the interaction data as described with reference to FIG. 5, and comparing the evaluation user clusters to the generated user clusters.

FIG. 8 shows an example of a directed graph 800 for an interaction dataset according to aspects of the present disclosure. Directed graph 800 is an example of, or includes aspects of, the corresponding element described with reference to FIG. 3. In one aspect, directed graph 800 includes first node 805, second node 810, third node 815, and fourth node 820.

Referring to FIG. 8, directed graph 800 is an example of a directed graph created for a user set including 8,000 users. In some cases, an amount of time spent on a digital platform (such as the digital platform described with reference to FIG. 3) by a user (such as the user described with reference to FIGS. 1 and 3) during a session, represented by first node 805, TimePerSession, is a good measure of a degree of engagement users have with the digital platform.

As shown in FIG. 8, TimePerSession is directly affected, with an edge weight of 0.65, by a number of times a user clicked on a particular page of the digital platform, represented by second node 810, NumPageHits, and, with an edge weight of 0.17, by a number of times the user visited the digital platform using a particular operating system, represented by third node 815, NumPromotionHitsSmartPhone. TimePerSession directly affects a number of times the user clicked on a promotion while using something other than the particular smart phone, represented by fourth node 820, NumPromotionHitsOthers, but in a negative manner and with smaller magnitude (e.g., edge weight),-0.09.

FIG. 9 shows an example of a first directed graph 900 for the interaction dataset of FIG. 8 according to aspects of the present disclosure. In one aspect, first directed graph 900 includes first node 905, second node 910, and third node 915. FIG. 10 shows an example of a second directed graph 1000 for the interaction dataset of FIG. 8 according to aspects of the present disclosure. In one aspect, second directed graph 1000 includes first node 1005, second node 1010, and third node 1015.

Referring to FIGS. 9 and 10 together, first directed graph 900 and second directed graph 1000 are example directed graphs for two user clusters of the set of 8,000 users represented by directed graph 800 of FIG. 8. For example, first directed graph 900 and second directed graph 1000 are obtained by using a machine learning model (such as the machine learning model of FIGS. 2-3) to obtain two user clusters, rather than one, for the 8,000 users. First directed graph 900 corresponds to a first user cluster including 6,469 users, and second directed graph 1000 corresponds to a second user cluster including 1,531 users.

As shown in FIGS. 9 and 10, first directed graph 900 and second directed graph 1000 are DAGs that differ in causal relations among the interaction data from each other and from directed graph 800. For example, in the first directed graph 900, the engagement metric TimePerSession (represented by first node 905) is directly affected, with an edge weight of 0.83, by NumPageHits, represented by second node 910, and, with an edge weight of 0.20, ProximityToTransaction (represented by third node 915).

Referring to directed graph 800 and first directed graph 900, for the first cluster, ProximityToTransaction increases TimePerSession, whereas for the entire user set, NumPromotionHitsSmartPhone increases TimeSpentPerSession. The attribute NumPageHits positively affects TimeSpentPerSession in both directed graph 800 and first directed graph 900, but with different effect sizes (0.65 versus 0.83, respectively). Therefore, directed graph 800 identifies NumPromotionHitsSmartPhone as a target interaction for positively impacting a TimePerSession goal interaction for the entire set of users, while first directed graph 900 identifies ProximityToTransaction as a target interaction for the TimePerSession goal interaction for users in the first cluster.

Likewise, referring to FIGS. 8 and 10, directed graph 800 and second directed graph 1000 both identify NumPageHits and NumPromotionHitsSmartPhone as target interactions for TimePerSession. Accordingly, taken together, first directed graph 900 and second directed graph 1000 indicate that the entire set of users represented by directed graph 800 are sortable into two learnable user clusters that are differentially targetable with different customized content.

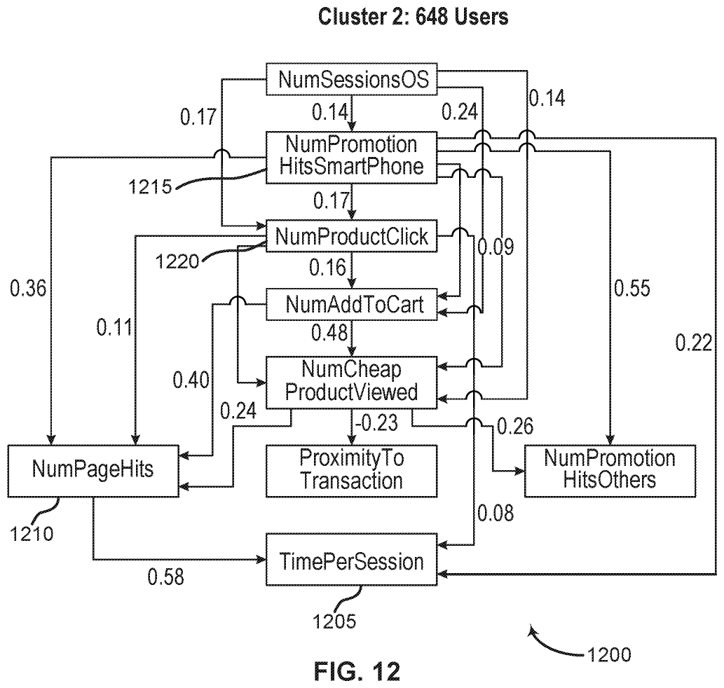

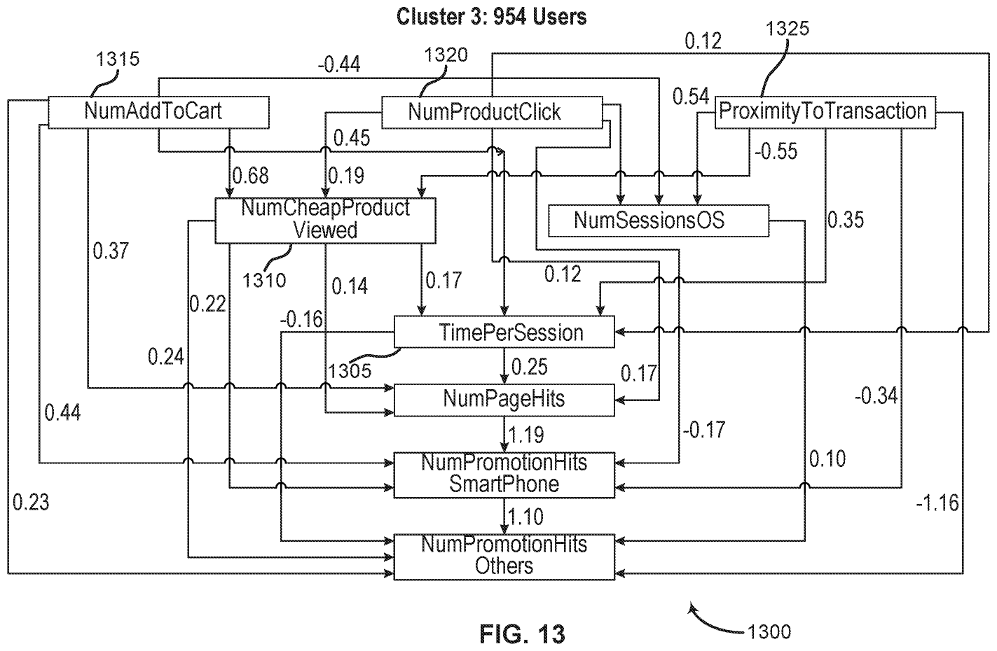

FIG. 11 shows an example of a third directed graph 1100 for the interaction dataset of FIG. 8 according to aspects of the present disclosure. In one aspect, third directed graph 1100 includes first node 1105, second node 1110, and third node 1115. FIG. 12 shows an example of a fourth directed graph 1200 for the interaction dataset of FIG. 8 according to aspects of the present disclosure. In one aspect, fourth directed graph 1200 includes first node 1205, second node 1210, third node 1215, and fourth node 1220. FIG. 13 shows an example of a fifth directed graph 1300 for the interaction dataset of FIG. 8 according to aspects of the present disclosure. In one aspect, fifth directed graph 1300 includes first node 1305, second node 1310, third node 1315, fourth node 1320, and fifth node 1325.

Referring to FIGS. 11-13, third directed graph 1100, fourth directed graph 1200, and fifth directed graph 1300 are example directed graphs for three user clusters of the set of 8,000 users represented by directed graph 800 of FIG. 8. For example, third directed graph 1100, fourth directed graph 1200, and fifth directed graph 1300 are obtained by using a machine learning model (such as the machine learning model of FIGS. 2-3) to obtain three user clusters, rather than one, or the two user clusters represented by FIGS. 9 and 10, for the 8,000 users. Third directed graph 1100 corresponds to a first user cluster including 6,398 users, fourth directed graph 1200 corresponds to a second user cluster including 648 users, and fifth directed graph 1300 corresponds to a third user cluster including 954 users.

As shown in FIGS. 11-13, third directed graph 1100, fourth directed graph 1200, and fifth directed graph 1300 are DAGs that differ in causal relations among the interaction data from each other and from directed graph 800. For example, in the third directed graph 1100, the engagement metric TimePerSession (represented by first node 1105) is directly affected by NumPageHits, represented by second node 1110, and ProximityToTransaction, represented by third node 1115 (similarly to the first directed graph of FIG. 9); in the fourth directed graph 1200, the engagement metric TimePerSession (represented by first node 1205) is directly affected by NumPageHits, represented by second node 1210, NumPromotionHitsSmartPhone, represented by third node 1215, and NumProductClick, represented by fourth node 1220; and in the fifth directed graph 1300, the engagement metric TimePerSession (represented by first node 1305) is directly affected by NumCheapProductViewed, represented by second node 1310, NumAddToCart, represented by third node 1315, NumProductClick, represented by fourth node 1320, and ProximityToTransaction, represented by fifth node 1325.

Accordingly, third directed graph 1100, fourth directed graph 1200, and fifth directed graph 1300 provide different possibilities for target interactions that ought to be used to target users included in a first cluster, a second cluster, or a third cluster of the set of 8,000 users, respectively. As shown in comparison to FIGS. 9 and 10, in the example, the target interactions for the respective clusters of users change based on the number of user clusters.

### Training

A method for data processing using machine learning is described with reference to FIG. 14. At least one aspect of the method includes obtaining training data including a user cluster and interaction data for users in the user cluster, wherein the interaction data relates to interactions between the users and a digital platform; training parameters of a machine learning model based on the user cluster and the interaction data, wherein the machine learning model corresponds to a directed graph representing causal relationships among the interactions; updating the user cluster based on the directed graph; and updating the parameters of the machine learning model based on the updated user cluster.

Some examples of the method further include obtaining a plurality of user clusters, wherein the interaction data relates to interactions from the plurality of user clusters. Some examples further include generating a plurality of directed graphs corresponding to the plurality of user clusters. Some examples further include updating the plurality of user clusters based on the plurality of directed graphs.

In some examples of the method, obtaining the training data comprises randomly assigning the users to the user cluster. In some examples of the method, obtaining the training data comprises assigning the users to the user cluster based on the interaction data.

In some examples of the method, training the parameters of the machine learning model comprises learning edges and weights of the directed graph. In some examples of the method, updating the user cluster comprises calculating a likelihood of a user being assigned to the user cluster based on the directed graph. Some examples of the method further include iteratively updating the user cluster and parameters of the machine learning model.

FIG. 14 shows an example of a method 1400 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 14, a data processing system (such as the data processing system described with reference to FIG. 1) trains a machine learning model (such as the machine learning model described with reference to FIGS. 2-3) corresponding to a directed graph to update a user cluster based on the directed graph. For example, according to some aspects, the machine learning model is an RNN characterized by nodes forming the directed graph (e.g., a directed acyclic graph (DAG)). According to some aspects, the machine learning model is characterized by nodes forming a set of directed graphs.

At operation 1405, the system obtains training data including a user cluster and interaction data for users in the user cluster, where the interaction data relates to interactions between the users and a digital platform. In some cases, the operations of this step refer to, or are performed by, a training component as described with reference to FIG. 2. For example, in some cases, the training component retrieves the training data from a database (such as the database described with reference to FIG. 1). According to some aspects, the training component retrieves the interaction data from the database and the machine learning model generates at least one user cluster based on the training data. For example, in some cases, the machine learning model randomly initializes the at least one user cluster. In some cases, the machine learning model assigns users to the at least one cluster based on similarities in the interaction data.

At operation 1410, the system trains parameters of the machine learning model based on the user cluster and the interaction data, where the machine learning model corresponds to a directed graph representing causal relationships among the interactions. In some cases, the operations of this step refer to, or are performed by, a training component as described with reference to FIG. 2.

According to some aspects, the machine learning model generates at least one directed graph for each user cluster as described with reference to FIG. 5. According to some aspects, the number of directed graphs is a hyperparameter of the machine learning model. According to some aspects, the machine learning component learns edges and weights for each directed graph. According to some aspects, the training component trains the parameters of the machine learning model by storing the learned edges and weights for each directed graph in a database (such as the database described with reference to FIG. 1).

At operation 1415, the system updates the user cluster based on the directed graph. In some cases, the operations of this step refer to, or are performed by, a machine learning model as described with reference to FIGS. 2 and 3. For example, in some cases, the machine learning model updates a user cluster corresponding to each directed graph as described with reference to FIG. 5. According to some aspects, the number of user clusters is a hyperparameter of the machine learning model.

At operation 1420, the system updates the parameters of the machine learning model based on the updated user cluster. In some cases, the operations of this step refer to, or are performed by, a training component as described with reference to FIG. 2. For example, according to some aspects, the machine learning model updates each directed graph, and therefore learns new edges and weights, based on each corresponding user cluster as described with reference to FIG. 5. According to some aspects, the training component stores the updated edges and weights in the database. According to some aspects, the machine learning model iteratively updates each directed graph and each user cluster until no difference between iterations of the set of user clusters is observed, as described with reference to FIG. 5.

The description and drawings described herein represent example configurations and do not represent all the implementations within the scope of the claims. For example, in some cases, the operations and steps are rearrangeable, combinable, or otherwise modifiable. Also, in some cases, structures and devices are represented in the form of block diagrams to represent the relationship between components and avoid obscuring the described concepts. In some cases, similar components or features have the same name but have different reference numbers corresponding to different figures.

Some modifications to the disclosure will be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

In some cases, the described methods are implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. In some cases, a general-purpose processor is a microprocessor, a conventional processor, controller, microcontroller, or state machine. In some cases, a processor is implemented as a combination of computing devices (e.g., a combination of a DSP and a microprocessor, multiple microprocessors, at least one microprocessor in conjunction with a DSP core, or any other such configuration). Thus, in some cases, the functions described herein are implemented in hardware or software and are executed by a processor, firmware, or any combination thereof. If implemented in software executed by a processor, the functions are in some cases stored in the form of instructions or code on a computer-readable medium.

Computer-readable media includes both non-transitory computer storage media and communication media including any medium that facilitates transfer of code or data. In some cases, a non-transitory storage medium is any available medium that is accessible by a computer. For example, in some cases, non-transitory computer-readable media comprises random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, in some cases, connecting components are properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” is also based on a condition B in some cases. In other words, the phrase “based on” shall be construed to mean “based at least in part on.” Also, the words “a” or “an” indicate “at least one.”

What is claimed is:

1. A method for data processing, comprising:
obtaining, by a machine learning model, a user cluster and interaction data for users in the user cluster, wherein the interaction data relates to interactions between the users and a digital platform;
generating, by the machine learning model, a directed graph based on the user cluster and the interaction data, wherein the directed graph represents causal relationships among the interactions;
updating, by the machine learning model, the user cluster based on the directed graph; and
providing, by a content component, customized content to a user via the digital platform based on the updated user cluster.

2. The method of claim 1, further comprising:
obtaining, by the machine learning model, a plurality of user clusters, wherein the interaction data relates to interactions from the plurality of user clusters;
generating, by the machine learning model, a plurality of directed graphs corresponding to the plurality of user clusters; and
updating, by the machine learning model, the plurality of user clusters based on the plurality of directed graphs.

3. The method of claim 1, wherein obtaining the user cluster comprises:
randomly assigning, by the machine learning model, the users to the user cluster.

4. The method of claim 1, wherein obtaining the user cluster comprises:
assigning, by the machine learning model, the users to the user cluster based on the interaction data.

5. The method of claim 1, wherein generating the directed graph comprises:
learning, by the machine learning model, edges and weights of the directed graph.

6. The method of claim 1, wherein updating the user cluster comprises:
calculating, by the machine learning model, a likelihood of a user being assigned to the user cluster based on the directed graph.

7. The method of claim 1, further comprising:
iteratively updating, by the machine learning model, the user cluster and the directed graph.

8. The method of claim 1, further comprising:
selecting, by the content component, a target interaction for the user based on the user cluster, wherein the customized content is provided based on the target interaction.

9. A method for data processing, comprising:
obtaining, by a training component, training data including a user cluster and interaction data for users in the user cluster, wherein the interaction data relates to interactions between the users and a digital platform;
training, by the training component, parameters of a machine learning model based on the user cluster and the interaction data, wherein the machine learning model corresponds to a directed graph representing causal relationships among the interactions;
updating, by the machine learning model, the user cluster based on the directed graph; and
updating, by the training component, the parameters of the machine learning model based on the updated user cluster.

10. The method of claim 9, further comprising:
obtaining, by the machine learning model, a plurality of user clusters, wherein the interaction data relates to interactions from the plurality of user clusters;
generating, by the machine learning model, a plurality of directed graphs corresponding to the plurality of user clusters; and
updating, by the machine learning model, the plurality of user clusters based on the plurality of directed graphs.

11. The method of claim 9, wherein obtaining the training data comprises:
randomly assigning, by the machine learning model, the users to the user cluster.

12. The method of claim 9, wherein obtaining the training data comprises:
assigning, by the machine learning model, the users to the user cluster based on the interaction data.

13. The method of claim 9, wherein training the parameters of the machine learning model comprises:
learning, by the machine learning model, edges and weights of the directed graph.

14. The method of claim 9, wherein updating the user cluster comprises:
calculating, by the machine learning model, a likelihood of a user being assigned to the user cluster based on the directed graph.

15. The method of claim 9, further comprising:
iteratively updating, by the machine learning model, the user cluster and parameters of the machine learning model.

16. An apparatus for data processing, comprising:
at least one processor;
at least one memory storing instructions executable by the at least one processor; and
a machine learning model comprising machine learning parameters stored in the one at least one memory component, the machine learning model trained to cluster users by generating a directed graph based on a user cluster and interaction data and updating the user cluster based on the directed graph.

17. The apparatus of claim 16, further comprising:
a monitoring component configured to collect the interaction data for a digital platform.

18. The apparatus of claim 16, further comprising:
a content component configured to generate customized content based on the user cluster.

19. The apparatus of claim 18, further comprising:
a user interface configured to display the customized content.

20. The apparatus of claim 16, further comprising:
a training component configured to update the parameters of the machine learning model.
